(19) United States
(12) Patent Application Publication
(10) Pub. No.: US 2013/0312073 A1
(43) Pub. Date: Nov. 21, 2013

(54) METHODS AND SYSTEMS FOR AUTHENTICATION OF MULTIPLE SIGN-IN ACCOUNTS

(71) Applicant: Rajdeep Srivastav, Saratoga, CA (US)

(72) Inventor: Rajdeep Srivastav, Saratoga, CA (US)

(21) Appl. No.: 13/472,883

(22) Filed: May 16, 2012

(51) Int. Cl. H04L 9/32; G06F 21/20

(52) U.S. Cl. 726/7

(57) ABSTRACT

Provided are systems and methods for authentication multiple sign-in accounts using physical authentication information submitted by user devices to authentication servers for accessing these accounts. A user device may be equipped with or coupled to a reader capable of collecting physical authentication information available on a magnetic strip, near field communication tag, and other devices. This information may be requested by an authentication server or application server. The physical authentication information may be combined with knowledge based information, such as a password, and transmitted to the authentication server for validation. The same authentication information may be used for signing-in to different application servers. The authentication server then validates this information based on user information previously provided to the server and stored in its database. The validation result is provided to the application server, which determines whether to provide access to the user device based on the validation result.

### FIELD

This application relates generally to automating sign-in processes and more specifically to using customer-based authentication devices for submitting authentication information to authentication servers for signing-in to multiple accounts corresponding to different application servers.

### BACKGROUND

User names and passwords are used by websites to authenticate users before allowing viewing content, performing specific actions, and other purposes. For example, a user may sign in to an online shopping website (e.g., Amazon) to manage his or her shopping cart, pay for items in the shopping cart, and request delivery. In another example, a user may sign in to a content providing website (e.g., Netflix) to get access to media content and view this content on his or her device. Control of user names and passwords is usually maintained on the Web server. That means that a browser of a user system sends a password to a corresponding web server. The web server then checks the password and sends back the relevant content or denies the access to the content. This process eliminates the possibility of local reverse engineering as the code used to authenticate the password does not reside on the user system.

A typical person may have tens if not hundreds of username and password combinations for various online accounts, such as e-mailing, shopping sites, banking and securities trading, gaming, social networking, work related activities, and the like. It is always a great challenge to remember all these combinations, keep them updated, and maintain them in a secure manner. Most typically, people rely on a simple combination that is used for most, if not all, accounts. However, this combination often provides little security and can be easily compromised by virtue of widespread use and simplicity.

The main deficiency of traditional password protection arises from a simple limitation of human memory. A fundamental psychology study by Miller entitled “The magical number seven, plus or minus two: Limits on our capacity for processing information” (Psychological Review vol. 63 (1956)) pointed out that the human memory for sequences of items is temporally limited and has a short-term capacity of only a few characters. Clearly, this human memory capacity is substantially less than even a minimal collection of username and password combinations required for Internet navigation and multiple account management. Furthermore, the same study pointed out that when humans remember a sequence of items, those items cannot be drawn from an arbitrary and unfamiliar range, but must be familiar “chunks” such as words or familiar symbols. This limitation of the human mind clearly undermines all computer security protocols requiring arbitrary and different combinations. Finally, human memory thrives on redundancy, which throws another challenge in computer security.

As a result, many security experts, who in the past asked people to memorize their passwords and “never write it down” now recommend that people use passwords that are too complicated to memorize and write them down on a paper. This approach has its own security flaws.

### SUMMARY

Provided are systems and methods for authentication of multiple sign-in accounts using physical authentication information submitted by user devices to authentication servers for accessing these accounts. A user device may be equipped with or coupled to a reader capable of collecting physical authentication information available on a magnetic strip, near field communication tag, and other devices. This information may be requested by an authentication server or application server. The physical authentication information may be combined with knowledge based information, such as a password, and transmitted to the authentication server for validation. The same authentication information may be used for signing-in to different application servers. The authentication server then validates this information based on user information previously provided to the server and stored in its database. The validation result is provided to the application server, which determines whether to provide access to the user device based on the validation result.

In certain embodiments, a method for using an authentication server to authenticate access to an application server involves receiving a request for authentication from the application server and receiving authentication information from a user device. The authentication information may include physical authentication information obtained by the user device. The method may also involve validating the authentication information received from the user device to generate a validation result and transmitting the validation result to the application server. The validation operation may include comparing the authentication information with user information available at the authentication server. The method may also involve repeating the receiving and validating operations if the validation result is negative. In certain embodiments, the method involves transmitting a report to the application server if the validation result is negative. The method may also involve counting a number of negative validation results and transmitting a report to the application server if the number reaches a predetermined value. In this example, the method may also involve blocking the user information available to the authentication server if the number reaches the predetermined value.

In certain embodiments, the physical authentication information includes one or more of the following: magnetic strip information, near field communication (NFC) tag information, radio frequency identification (RFID) information, and biometrics information. In specific embodiments, the physical authentication information includes magnetic strip information stored on a bank card. The physical authentication information may be obtained by a credit card reader coupled to the user device.

In certain embodiments, the method also involves transmitting a request for the authentication information to the user device. In the same or other embodiments, the validation result may include a subset of the user information corresponding to the authentication server. For example, the validation result may include a specific combination of a username and password specific for this authentication server. The validation information may also include other user specific information, such as shipping information, contact information, payment information, and the like.

In certain embodiments, the method for using the authentication server also involves receiving an additional request for authentication from an additional application server and receiving the authentication information from the same user device. The method then proceeds with validating the authentication information to generate an additional validation result and transmitting the additional validation result to the additional application server. As such, a user may use the same service and authentication information to connect to different servers. For example, a user may use a bank card swipe and password to connect to an online shopping website first and then use the same bank card and password to connect to an e-mail account. In certain embodiments, the user may choose to use different physical authentication information for different accounts (e.g., differentiating between more secure and less secure accounts). Furthermore, a user may couple the same physical authentication information with different knowledge based information (e.g., passwords for signing-in to different application servers).

In certain embodiments, the authentication information is stored on the user device as a cookie. This allows the user to avoid repetitive sign-ins to the same application server. In certain embodiments, information for the cookie is provided by the authentication server. As stated above, the authentication information may include knowledge based authentication information, such as a password or some other information known to the user (e.g., date of birth, address, and the like). This information is generally not known to other parties in order to maintain the security of the overall system.

In certain embodiments, the authentication information may be based on multiple factors and therefore may be referred to as multifactor authentication information. Multifactor authentication information includes at least one or more types of physical information, such as information obtained from a magnetic strip or NFC tag. In certain embodiments, multifactor authentication information also includes other types of information, such as knowledge based authentication information. The validation result provided by this method may include one or more information types, such as payment information, shipping information, and customer preference information.

Provided also is an authenticating server that may include a communication module for receiving a request for authentication from an application server, receiving authentication information from a user device, and transmitting a validation result. The authentication server may also include a database including user information available and an authentication module for validating the authentication information received from the user device by comparing the authentication information with the user information. In certain embodiments, the authentication server includes a processing module to generate the validation result, identify a number of validation operations, and instruct the communication module to transmit the validation result.

Also provided is a method for retrieving authentication information from an authentication server. The method may involve providing a sign-in interface (including an authentication service option) to a user device, receiving a request from the user device to use the authentication service option, and transmitting the authentication request to the authentication server. The method may also involve receiving a validation result from the authentication server and, based on a status of the validation result, allowing or not allowing access to the user device. The sign-in interface may also include a direct application server authentication option. Transmitting the authentication request may include transmitting authentication information received from the user device. The authentication information includes physical authentication information obtained by the user device. The validation result may include one or more information types selected from the group consisting of payment information, shipping information, and customer preference information.

Other features, examples, and embodiments are described below.

### BRIEF DESCRIPTION OF THE DRAWINGS

FIG. 1 is a schematic high level representation of a networked system for authentication of multiple sign-in accounts, in accordance with certain embodiments.

FIG. 2 is a schematic representation of various components of the authentication server, in accordance with certain embodiments.

FIG. 3A is a process flow chart corresponding to a method for setting up an authentication account with an authentication server, in accordance with certain embodiments.

FIG. 3B is a process flow chart corresponding to a method for using an authentication server to authenticate access to an application server, in accordance with certain embodiments.

FIG. 4 is a process flow chart corresponding to a method for using an application server to retrieve authentication information from an authentication server, in accordance with certain embodiments.

FIG. 5 is a diagrammatic representation of an example machine in the form of a computer system, within which a set of instructions for causing the machine to perform any one or more of the methodologies discussed herein may be executed.

FIGS. 6A-6D are schematic representations of user interfaces during signing-in to a shopping website using an authentication service, in accordance with certain embodiments.

FIGS. 7A-7C are schematic representations of user interfaces during signing-in to an e-mail website using an authentication service, in accordance with certain embodiments.

### DESCRIPTION OF EXEMPLARY EMBODIMENTS

Typical computer authentication methods rely on users to submit their user names and text passwords. The vulnerabilities of this method are well known. One of the main problems is the difficulty of remembering passwords. It has been shown that users tend to pick short passwords or passwords that are easy to remember. Unfortunately, these passwords can also be easily guessed or broken. Furthermore, users often reuse their username-password combinations throughout multiple accounts, and compromising one account can compromise many other ones.

Proposed methods and systems reply on authentication servers to support application servers during authentication and physical authentication at a user level. Adding an authentication server allows combining multiple sign-in accounts typically associated with multiple application servers into a single authentication account supported by the authentication server. Instead of remembering multiple combinations of usernames and passwords for all application server accounts, a user may link these accounts to an authentication server and use a single sign-in account at the authentication server to access all linked application servers. Once the authentication server verifies and approves the user, it informs one or more application servers of this approval. The one or more applications in turn grant access based on this information.

Furthermore, additional security is ensured by using physical authentication, which may be combined with knowledge based authentication. Physical authentication may be based on one or more physical attributes that are available to a specific user and that are provided by the user to his or her computer system for transmission to an authentication server. For example, bank cards, drivers licenses, physical tokens, biometric sources, and many other types of physical objects can be used by users to provide physical authentication information. Various types of readers or scanners may be attached to a computer system to achieve this result. This physical authentication information may be coupled with knowledge based information, such as a personal identification number or password, to enhance security. In general, multifactor authentication may be used where one or more factors include physical authentication information.

Some overview of proposed methods and systems may be provided by the following example. A user with multiple sign-in accounts needs to first register with an authentication server. This registration may involve providing physical authentication information by way of retrieving this information from a scanner or reader, which may be attached to or integrated into a user device, and transmitting this information to the authentication server. In a specific example, a card reader may be attached to a computer system, and a user may use his or her bank card, drivers license, or any other types of cards that include a magnetic strip to swipe through the reader and provide this information to the computer system. The computer system is connected to the authentication server through one or more networks, such as the Internet. The authentication server may also request some knowledge based information to be coupled to this physical authentication information in order to improve security. Overall multifactor authentication may be used for security with one or more factors being represented by physical authentication information. For example, one factor may be physical authentication information, while another factor may be knowledge based information. In the same or other examples, two or more factors may be physical authentication information (e.g., a credit card scan and drivers license scan).

This authentication information is used by the authentication server to identify a user and then instruct one or more application servers to grant access to this user. The application servers may be subscribed to the authentication services provided by the authentication server, and no separate accounts need to be set up by the user to access these application servers. In other words, the application servers use the information generated and provided by the authentication server about the user to grant access to the content. This information may be the same for different application servers. Alternatively, the information may vary, depending, for example, on the type of authentication server. For example, an e-mail server may be provided with a basic authorization and user identification, while an online shopping server may be also provided with shipping information and/or payment information.

In other embodiments, an application server may be specifically set-up for interacting with the authentication server. In these embodiments, the authentication server may be used as a database of sign-in information specific for this application server. For example, a user may independently set-up an account on this application server. The user may then store a username and password combination corresponding to this account. During later operations, the user may direct the authentication server to push the username and password combination to the application server on behalf of the user. This operation may be completed by direct communication between the authentication and application servers or by information provided back to the user device by the authentication server for later transmission to the application server.

Once the authentication account is set up, the user may attempt to access one of the application servers and may be presented with a user interface indicating availability of an authentication service associated with the authentication server. The user may select this authentication service or proceed with an alternative sign-in option, such as providing a username and password combination. If the authentication service is requested, the user may be prompted to provide physical authentication information by, for example, swiping a card through a card reader connected to the user device. The user may be also prompted to provide knowledge based information.

The authentication information collected from the user is then validated by the authentication server to generate a validation result. A validation result may be positive, which means that the authentication server confirms the authentication information being correct, or negative, which means that the authentication server identifies certain problems in the provided authentication information. In the latter case, when the validation result is negative, the authentication server may request that a user provide authentication information again. For example, a user may have mistakenly swiped a wrong card and/or entered a wrong password. This repetition may be initiated with or without informing the application server that the user is attempting to access. In certain embodiments, after the process generates a certain predetermined number of negative validation results, the authentication server may inform the application server and/or may lock-out the user account. The lock-out may be a timeout or require certain additional information from the user to return to the operating mode.

If the validation result is positive, then the authentication sever may transmit the validation result to the application server. Based on this result, the application server may grant the user access to the content. The validation result may also contain other user information, such as user payment information, user shipping information, location, and the like, that may be useful to the application server to provide a better service to the user.

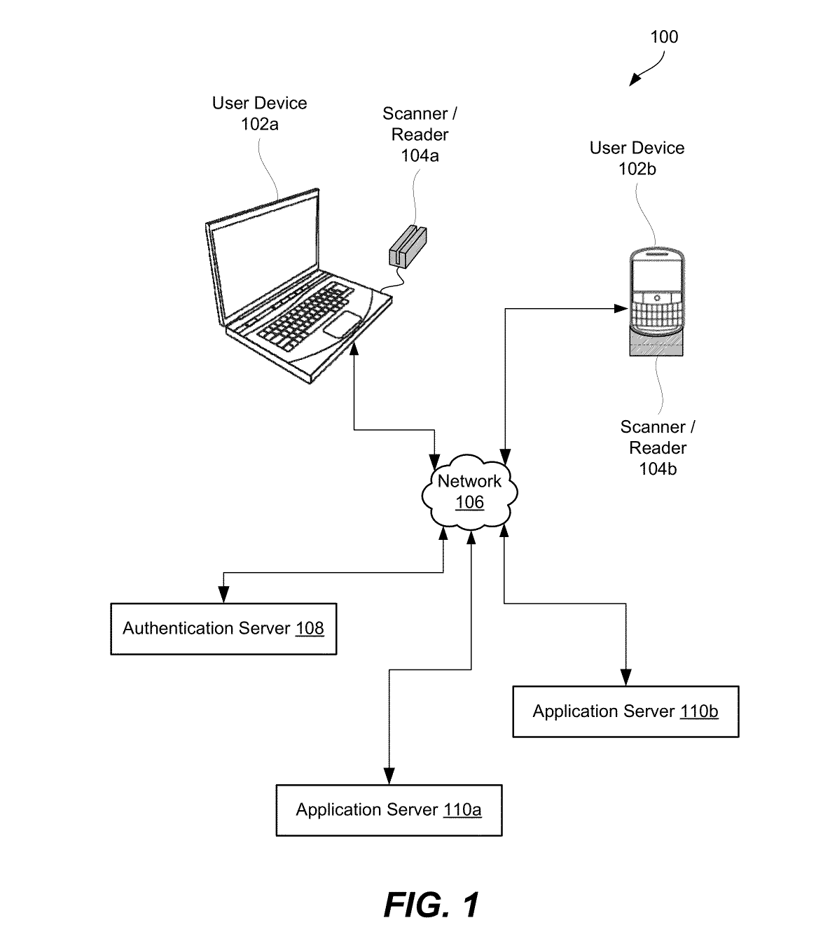

FIG. 1 is a schematic high level representation of a networked system 100 for authentication of multiple sign-in accounts, in accordance with certain embodiments. Networked system 100 may include one or more user devices 102a and 102b that have scanners/readers 104a and 104b attached to or integrated into user devices 102a and 102b. Networked system 100 also includes at least one authentication server 108 and one or more application servers 110a and 110b. In certain embodiments, one authentication server 108 is capable of supporting multiple application servers 110a and 110b. Furthermore, an application server may use different authentication servers for the same type of authentication services. User devices 102a and 102b, authentication server 108, and application servers 110a and 110b are interconnected using a network 106. Each of these components will now be described in more detail.

User devices 102a and 102b may be any types of computer systems capable of attaching to or including scanners/readers 104a and 104b. User devices 102a and 102b may include additional input and output means, such as mice, keyboards, and screens. Some examples of user devices 102a and 102b include desktops, laptops, notebooks, ultra-books, tablet computers, handheld computers, personal digital assistants (PDAs) (e.g., palmtop computers, enterprise digital assistants), mobile phones (e.g., smartphones), portable media players, E-book readers, game consoles, and head mounted displays.

Various types of scanners/readers 104a and 104b may be used. One example is a magnetic card reader. A magnetic stripe card is a type of card capable of storing data by modifying the magnetism of tiny iron-based magnetic particles on a band of magnetic material on the card. The magnetic stripe card may be also referred to as a swipe card, magnetic card, or mag-stripe. The card is read by physical contact and swiping past a magnetic reading head of the reader. The card and reader may follow one or more of the following standards: ISO/IEC 7810, ISO/IEC 7811, ISO/IEC 7812, ISO/IEC 7813, ISO 8583, and ISO/IEC 4909, which define the physical properties of the card, including size, flexibility, location of the stripe, magnetic characteristics, and data formats. The magnetic stripe may contain three tracks—tracks one and three are typically recorded at 210 bits per inch, while track two typically has a recording density of 75 bits per inch. Each track can either contain 7-bit alphanumeric characters or 5-bit numeric characters.

Examples of magnetic cards that follow the standards include ATM cards, bank cards (credit and debit cards including VISA and MasterCard), gift cards, loyalty cards, drivers licenses, telephone cards, membership cards, electronic benefit transfer cards (e.g., food stamps), game cards, library cards, and other types of cards. Other types of cards may ignore the standards listed above. Examples of these cards include hotel key cards, public transportation cards, prepaid calling cards, and other types.

When a three-track card is used by a networked system 100, one or more tracks may be used to retrieve necessary physical information. The information on the tracks may include a primary account number (PAN), which may be up to 19 characters and may correspond to a credit card number, bank account number, or some other number. It may also include a name of the user, which may be between 2 to 26 characters, expiration date, which may be four characters, service code, pin verification key indicator, and other types of information. Other examples of information that are typically found on drivers licenses include address, name, identification number, expiration date, birthdate, height, weight, hair color, eye color, and other information. Any combination of these data points can be used to provide physical authentication information from user devices 102a and 102b to authentication server 108.

Another type of scanners/readers 104a and 104b may be smart card readers capable of retrieving information from smart cards that contain an integrated circuit chip. Some of these cards may have metal contacts connecting the card physically to the reader. Other types of smart cards include contactless cards using a magnetic field or RFID for proximity reading.

Furthermore, a user may have an authentication token issued by the service provider. The information supplied by this token may be entered directly into user devices 102a and 102b, and scanners/readers 104a and 104b may not be necessary. For example, a token may display a changing passcode on an LCD or e-ink display, which must be typed in to the authentication screen of user devices 102a and 102b. This number may be derived from a cryptographic process shared with authentication server 108. In certain embodiments, a connected token may be used to eliminate the need to read and type a pass code from the device. Some types require a device reader and possibly special device drivers, whereas others use an interface which is almost universally available, such as USB. Any USB memory device can be used as a token simply by storing a secret passcode on it with a security feature that prevents it from being copied. Yet another example of a connected token is a virtual token. Virtual tokens utilize the user's existing internet device as the “something the user has” factor and, since the user's internet device is communicating directly with the authentication server, the solution does not suffer from man-in-the-middle attacks and similar forms of online fraud.

In certain embodiments, a mobile phone may be used to generate physical authentication information to be provided to authentication server 108. A mobile phone may be transformed into a token device using SMS messaging or an interactive telephone call or via a downloadable application to a smartphone. Since the mobile phone communicates over two channels (i.e., sending and receiving), the mobile phone becomes a two-factor two-channel authentication mechanism. For example, a one-time password may be sent via an SMS to the user as part of the authentication process. Push notification services made available using smartphone platforms, such as iPhone and Android, can be used to provide a real-time challenge/response mechanism on a mobile device. Upon performing authentication, the user will instantly: receive a challenge pushed to their mobile phone, be prompted with the full details of that transaction, and be able to respond to approve or deny that transaction by simply pressing a button on their mobile phone.

In certain embodiments, physical authentication information may include biometrics data. Users may biometrically authenticate via their fingerprint, voiceprint, or iris scan using specific scanners/readers 104a and 104b or scanners included in user devices 102a and 102b, such as cameras. Biometric identifiers may be rendered into strings or mathematic information. The device scans the physical characteristic, extracts critical information, and then stores the result as a string of data. This data is then transmitted to authentication server 108 for validation. Comparison at authentication server 108 is therefore made between two data strings, and if there is sufficient commonality a positive validation result is generated.

User devices 102a, 102b may be connected to authentication server 108 and application servers 110a and 110b using network 106. Network 106 may take any suitable form, such as a wide area network (WAN) or Internet and/or one or more local area networks (LANs). Network 106 may include any suitable number and type of devices (e.g., routers and switches) for forwarding commands, content, and/or web object requests from each user to the online community application and responses back to the users.

The systems and methods described herein may also be practiced in a wide variety of network environments including, for example, TCP/IP-based networks, telecommunications networks, wireless networks, and so forth. In addition, the computer program instructions may be stored in any type of computer-readable media. The program may be executed according to a variety of computing models including a user/server model, a peer-to-peer model, a stand-alone computing device, or according to a distributed computing model in which various functionalities described herein may be effected or employed at different locations.

User devices 102a, 102b are capable of supporting web browsers to generate user interfaces. Web browsers allow users to access various applications on application servers 110a and 110b and communicate with authentication server 108. Each user device 102a, 102b may have browser software installed therein. Web browsers installed on user devices 102a, 102b should be supported by web servers of authentication server 108 and application servers 110a and 110b. Some examples of web browsers include Netscape Navigator, Netscape Communicator, Internet Explorer, Opera, Mozilla Navigator, Safari, Mozilla Firefox, and Google Chrome.

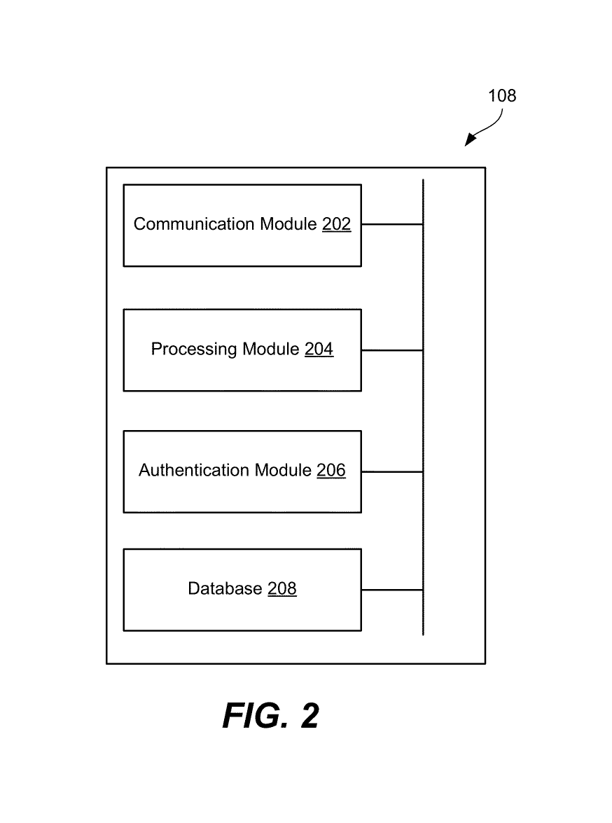

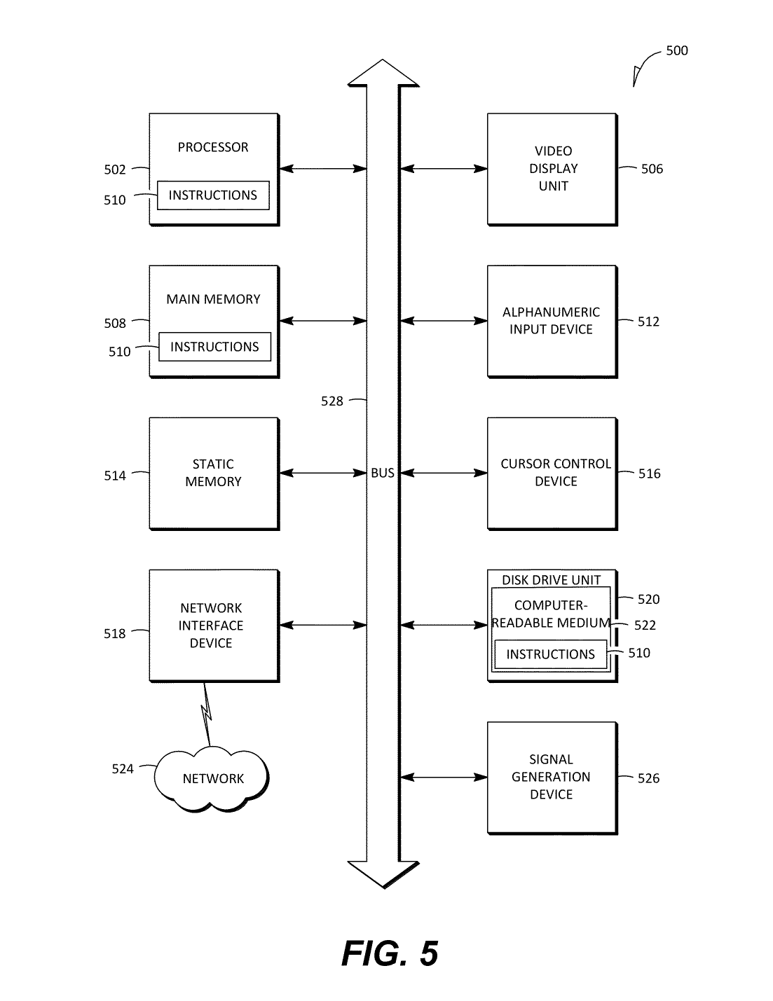

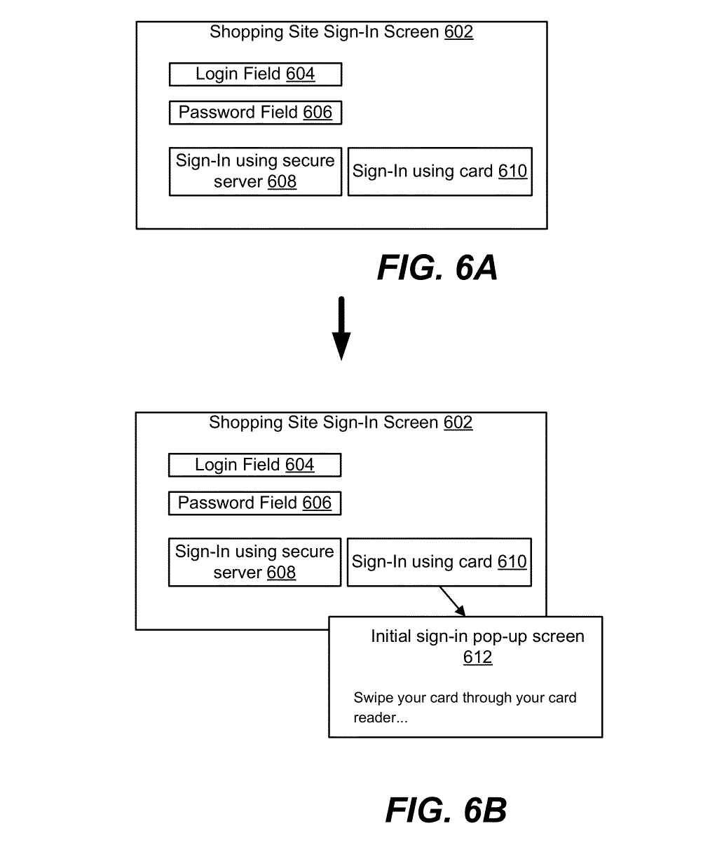

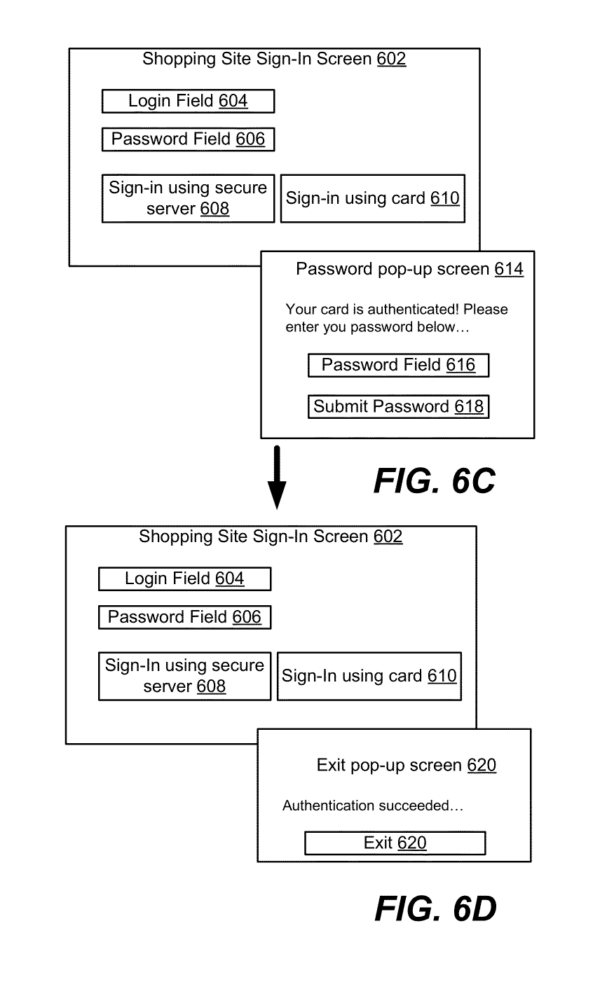

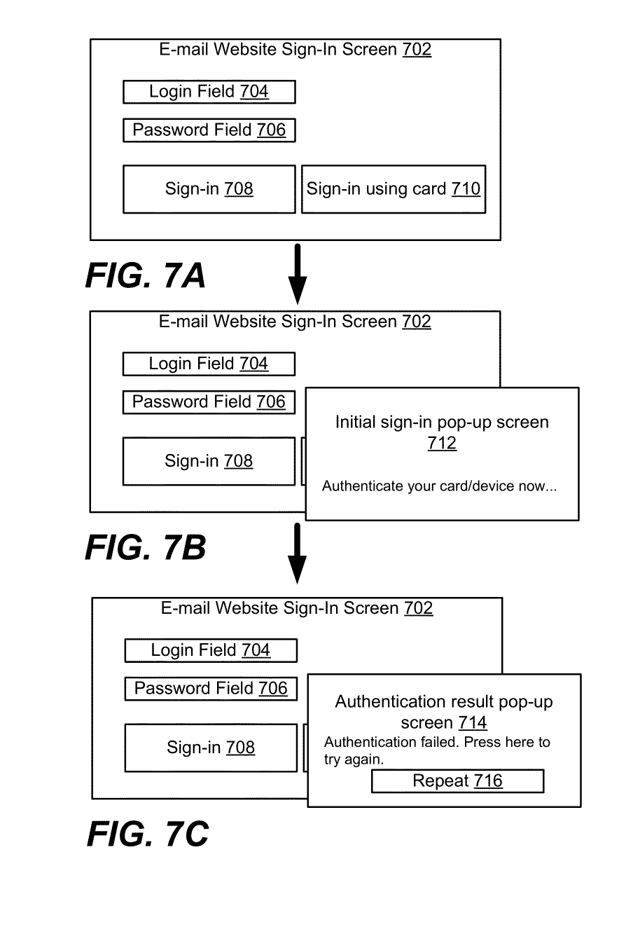

Application servers 110a and 110b may vary depending on their functions. Some applications are described below with reference to FIGS. 6A-6D and FIGS. 7A-7C. Authentication server 108 includes various components for performing various functions described below. FIG. 2 is a schematic representation of some of these components of authentication server 108, in accordance with certain embodiments. For example, authentication server 108 may include a communication module 202. Communication module 202 may be used for receiving requests for authentication from one or more application servers or, more generally, communication with one or more application servers. Other types of communication may include transmitting validation results and other information to one or more application servers. Furthermore, communication module 202 may be used for receiving authentication information from one or more user devices and, in certain embodiments, requesting this information from one or more user devices. Communication module 202 may include a web server and other types of hardware and/or software.

Another component of authentication server 108 is database 208. Database 208 may be used for storing information that corresponds to users and/or application servers. For example, database 208 may include user information available for validating. During validation, the user information may be compared to physical authentication information and/or other information received from a user device. Furthermore, database 208 may include user information that is shared with application servers upon successful validation of the request. Examples of this information are listed elsewhere in this document and include user's name, address, shipping information, payment information, and the like.

Authentication server 108 may also include an authentication module 206 for validating the authentication information received from the user device. This authentication may be conducted by comparing the authentication information with the user information. In certain embodiments, an exact match is required. For example, particular information obtained from a magnetic card and user input (e.g., knowledge based information) is compared to user information available in the database 208. In other embodiments (e.g., where biometric data is used), the match may not be exact, but needs to meet a certain predetermined threshold.

Authentication module 206 may be configured to work closely with a processing module 204 that may be used for generating the validation result. In certain embodiments, processing module 204 may be also used for identifying a number of validation operations. For example, processing module 204 may count a number of failed validations and block a user account when a number of failed attempts exceeds a certain predetermined number. Processing module 204 may be also used for instructing the communication module in transmitting the validation result.

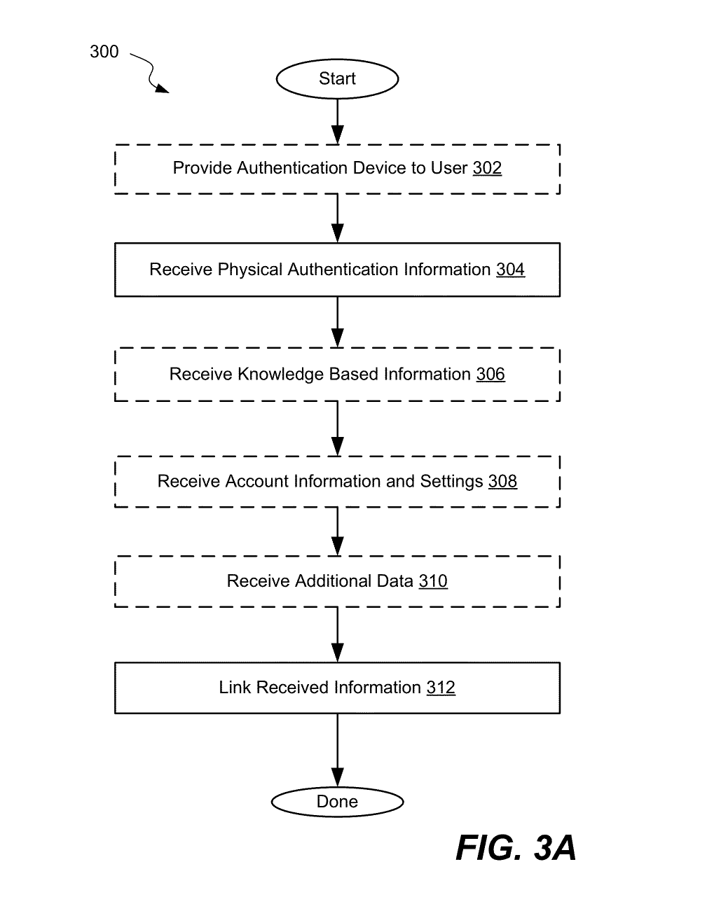

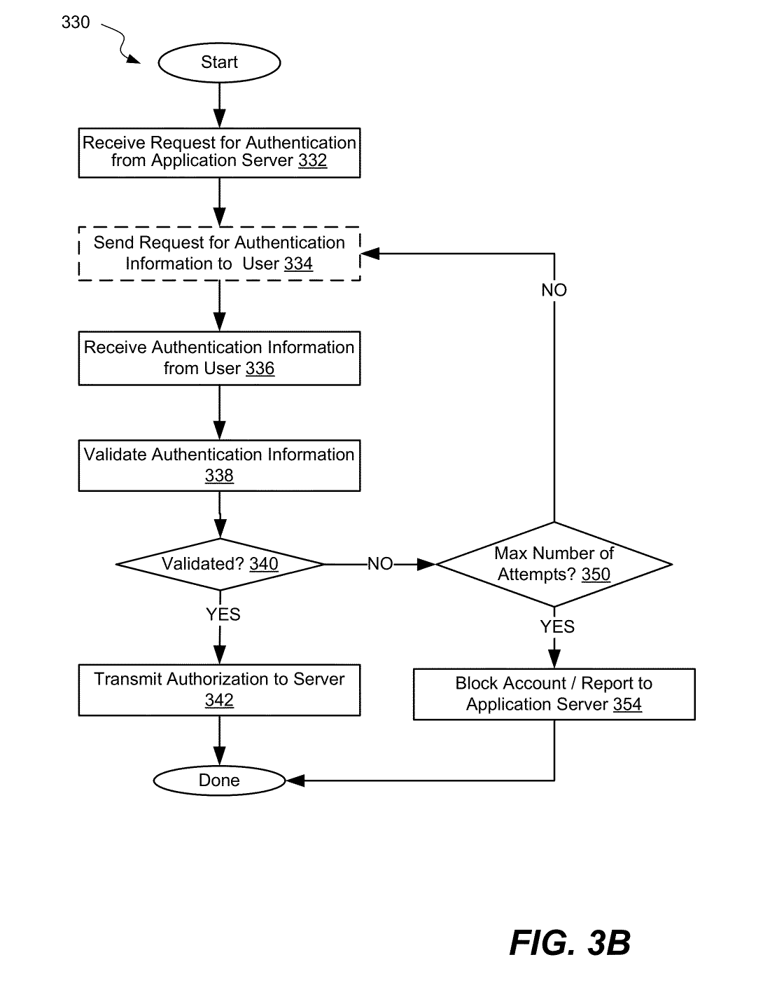

Methods of using various components of authentication server 108 will now be described with reference to FIGS. 3A and 3B. Specifically, FIG. 3A is a process flow chart corresponding to a method 300 for setting up an authentication account with an authentication server, in accordance with certain embodiments. Method 300 may commence with providing an authentication device to the user during optional operation 302. For example, an authentication service provider may issue a card reader or some other type of reader or scanner to a user. The user then attaches this scanner or reader to his or her device (e.g., a computer system). In certain embodiments, a user device may be already equipped with a necessary scanner or reader.

Method 300 may proceed with receiving physical authentication information from a user device during operation 304. For example, a user may swipe a magnetic card through his or her reader. The information contained in the card may be initially processed by the user device and then transmitted to the authentication server. In certain embodiments, any information received during the account set-up process is linked to the account (e.g., by repeatedly executing operation 312). In other embodiments, all information received during various operations further described below is linked together at the end of the process. Operation 304 may be repeated to validate the initial physical authentication information. For example, multiple biometrics data points may be taken to ensure accuracy. Furthermore, operation 304 may be repeated to gather additional physical authentication information that may be used in combination with the initial physical authentication information. For example, a user may use a combination of a credit card and drivers license to authenticate his or her account in the future. Multiple physical authentication information components may also be used as alternatives. For example, a user may be given an option to use either his or her credit card or drivers license depending on availability of the document.

In certain embodiments, method 300 proceeds with receiving knowledge based information during optional operation 306. For example, a user may provide a password or some other identifying information that is not generally available. Knowledge based information may be combined with physical authentication information to improve overall security. Method 300 may include a number of other optional operations, such as receiving account information and settings (operation 308) and/or receiving additional information (operation 310). Operation 308 may involve providing username and password combinations for specific application servers that are later retrieved by the authentication server upon validation of the user and either sent to the user device or directly to the application servers. Furthermore, information provided to the authentication server during set up of the account may include various user information, such as user name, shipping address, billing address, payment information, user preferences, and other such information. At some point, all or some information received by the authentication server during the set-up process is linked together into an account during operation 312.

FIG. 3B is a process flow chart corresponding to a method 330 for using an authentication server to authenticate access to an application server, in accordance with certain embodiments. Method 330 may commence with receiving a request for authentication from the application server during operation 332. For example, a user may try to access restricted content of the application server. The application server offers, to the user, to conduct an authentication process using the methods and systems described herein. Once the user requests this type of authentication, the application server generates an appropriate request to the authentication server. It should be noted that a user may be offered other authentication alternatives, and this process may not always be triggered by the application server.

Once the request for authentication is received during operation 332, the authentication server may send a request for physical authentication information to the user during optional operation 334. The request may be sent directly to the user device if this user device has been identified to the authentication server by the application server (e.g., in the request sent during operation 332). In other embodiments, the request for physical authentication information is sent to the application server, and the application server then transmits this request to the user device. For example, an application server may generate a pop-up window in the browser to request that the user provide physical authentication information.

At some point, authentication information is received by the authentication server, as identified by operation 336. As noted above, the authentication information includes physical authentication information obtained by the user device. In certain embodiments, the authentication information also includes knowledge based information and other type of information.

Method 330 may proceed with validating the received authentication information received to generate a validation result during operation 338. Validating may involve comparing the authentication information with user information available at the authentication server. If the authentication information is validated (as identified by the decision block 340), then the authentication server may proceed with transmitting a positive validation result to the application server during operation 342. The application server may in turn use these results to grant access to the requested (but restricted) content to the user. However, if the authentication information is not validated (as also identified by the decision block 340), then the authentication server may proceed with determining how many successful validation attempts have been performed (as reflected by the decision block 350). If the authentication server determines that a maximum number of unsuccessful attempts has been exceeded, then method 330 may proceed with blocking the user account and reporting to the application server about the failure to authenticate the user (as reflected by the block 354). The process may be completed at this point. However, if the maximum number of unsuccessful attempts has not been reached, then the application server may repeat operations 334-340.

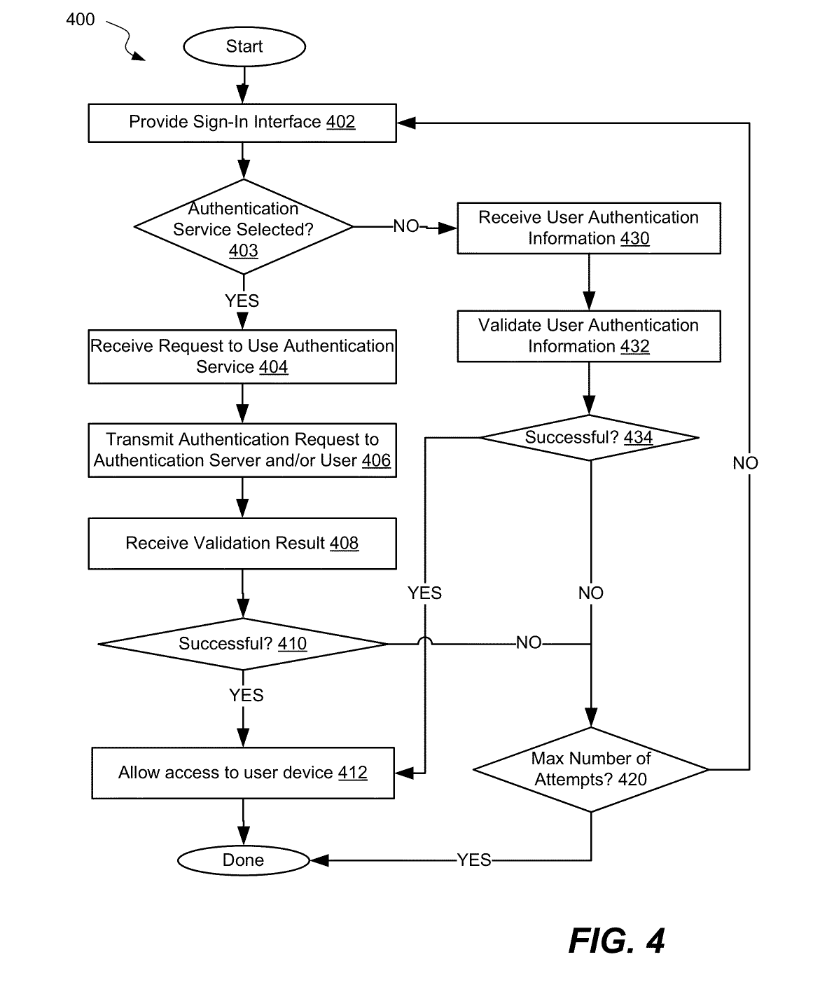

FIG. 4 is a process flow chart corresponding to another method 400 for using an application server to retrieve authentication information from an authentication server, in accordance with certain embodiments. Method 400 may commence with providing a sign-in interface to a user device, with the sign-in interface comprising an authentication service option (operation 402). Examples of such interfaces are shown in FIGS. 6A and 7A. The authentication service option may be provided alongside another authentication option (for example, for direct sign-in into the application server using a conventional username and password combination). If the user selects this other authentication option (as reflected by decision block 403), then method 400 may proceed with receiving user generated authentication information (e.g., a username and password combination) during operation 430 and validating this information during operation 432. The successful validation may complete the process (as reflected by decision block 434), and the user may be granted access to the requested information (block 412). On the other hand, if the user generated authentication information is not validated (as reflected by decision block 434) and additional attempts are available (as reflected by decision block 420), the user may be brought back to the sign-in interface comprising the authentication service option (operation 402).

If, however, a user selects the authentication service option at decision block 403, then the application server may receive a corresponding request from the user device to use the authentication service option (as reflected by operation 404). Method 400 may proceed with transmitting the authentication request based to the authentication server during operation 406 and effectively initiating the authentication process performed by the authentication server and described above. During this process, the user may be brought through a series of user interfaces (examples of which are presented in FIGS. 6B-6C and 7B).

At some point, a validation result from the authentication server is received by the application server during operation 408. The validation result may be either positive or negative. The validation result may also include user information, as described above. Based on the status of the validation result (as reflected by the decision block 410), the authentication may allow access to the user device during operation 412, at which point the process may be complete. At this point, the user may be presented with the user interface indicating the successful validation (one example of which is presented in FIG. 6D).

Alternatively, if the validation result is negative, then method 400 may proceed with determining if a number of unsuccessful attempts has reached a predetermined number (as reflected by decision block 420), and the process may be repeated or ended. The user may be also presented with the user interface indicating the failure to authenticate (one example of which is presented in FIG. 7C). It should be noted that a user may alternate between the user authentication reflected by operations 430 and 432 and automated authentication reflected by operations 404-408 one or more times.

FIG. 5 is a diagrammatic representation of an example machine in the form of a computer system 500, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a user machine in a server-user network environment, or as a peer machine in a peer-to-peer (or distributed) network environment. The machine may be a personal computer (PC), a tablet PC, a set-top box (STB), a PDA, a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor or multiple processors 502 (e.g., a central processing unit (CPU), a graphics processing unit (GPU), or both), and a main memory 508 and static memory 514, which communicate with each other via a bus 528. The computer system 500 may further include a video display unit 506 (e.g., a liquid crystal display (LCD)). The computer system 500 may also include an alphanumeric input device 512 (e.g., a keyboard), a cursor control device 516 (e.g., a mouse), a voice recognition or biometric verification unit (not shown), a disk drive unit 520, a signal generation device 526 (e.g., a speaker) and a network interface device 518. The computer system 500 may further include a data encryption module (not shown) to encrypt data.

The disk drive unit 520 includes a computer-readable medium 522 on which is stored one or more sets of instructions and data structures (e.g., instructions 510) embodying or utilizing any one or more of the methodologies or functions described herein. The instructions 510 may also reside, completely or at least partially, within the main memory 508 and/or within the processors 502 during execution thereof by the computer system 500. The main memory 508 and the processors 502 may also constitute machine-readable media.

The instructions 510 may further be transmitted or received over a network 524 via the network interface device 518 utilizing any one of a number of well-known transfer protocols (e.g., Hyper Text Transfer Protocol (HTTP)).

While the computer-readable medium 522 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

FIGS. 6A-D are schematic representations of user interfaces during sign-in into a shopping website using an authentication service, in accordance with certain embodiments. FIG. 6A represents a shopping site sign-in screen 602 with a login field 604, password field 606, control to sign-in using a secure server 608, and control to sign-in using a card 610. When control to sign-in using a card 610 is selected, initial sign-in pop-up screen 612 may be displayed, as represented by FIG. 6B. Initial sign-in pop-up screen 612 contains instructions on user actions required for authentication. After a user performs the required actions (for example, swipes his card through a card reader), password pop-up screen 614 appears, as represented by FIG. 6C. Password pop-up screen 614 may include controls to provide a user password (for example, password field 616) and control to submit password 618. When user password information is provided, exit pop-up screen 620 appears (see FIG. 6D). This screen may include information on the result of authentication and control to exit 620 pop-up.

FIGS. 7A-7C are schematic representations of user interfaces during signing into an e-mail website using an authentication service, in accordance with certain embodiments. FIG.7A represents an e-mail website sign-in screen 702 with a login field 704, password field 706, control to sign-in 708, and control to sign-in using a card 710. When control to sign-in using a card 710 is selected, initial sign-in pop-up screen 712, may be displayed, as represented by FIG. 7B. Initial sign-in pop-up screen 712 contains instructions on user actions required for authentication using a card. After a user performs the required actions (for example, swipes a card through a card reader), authentication result pop-up screen 714 appears, as represented by FIG. 7C. If authentication fails, authentication result pop-up screen 714 may contain information on the result of authentication and control to repeat an authentication procedure 716.

What is claimed is:

1. A method for using an authentication server to authenticate access to an application server, the method comprising:
receiving a request for authentication from the application server;
receiving authentication information from a user device, the authentication information comprising physical authentication information obtained by the user device;
validating the authentication information received from the user device to generate a validation result; and
transmitting the validation result to the application server.

2. The method of claim 1, wherein validating comprises comparing the authentication information with user information available at the authentication server.

3. The method of claim 1, further comprising repeating a receiving operation and a validating operation if the validation result is negative.

4. The method of claim 1, further comprising transmitting a negative validation report to the application server if the validation result is negative.

5. The method of claim 1, further comprising counting a number of negative validation results and transmitting a maximum number report to the application server if the number reaches a predetermined value.

6. The method of claim 1, wherein the physical authentication information comprises information selected from the following group: magnetic strip information, near field communication (NFC) tag information, radio frequency identification (RFID) information, and biometrics information.

7. The method of claim 1, wherein the physical authentication information comprises magnetic strip information stored on a bank card.

8. The method of claim 1, wherein the physical authentication information is obtained by a credit card reader coupled to the user device.

9. The method of claim 1, further comprising transmitting a request for the authentication information to the user device.

10. The method of claim 1, wherein the validation result comprises a subset of the user information corresponding to the authentication server.

11. The method of claim 1, further comprising
receiving an additional request for authentication from an additional application server;
receiving the authentication information from the user device;
validating the authentication information to generate an additional validation result; and
transmitting the additional validation result to the additional application server.

12. The method of claim 1, wherein the authentication information is stored on the user device as a cookie.

13. The method of claim 1, wherein the authentication information comprises knowledge based authentication information.

14. The method of claim 1, wherein the authentication information is multifactor authentication information comprising one or more types of physical information.

15. The method of claim 1, wherein the validation result comprises one or more information types selected from the group consisting of payment information, shipping information, and customer preference information.

16. An authentication server comprising:
a communication module for receiving a request for authentication from an application server, receiving an authentication information from a user device, and transmitting a validation result;
a database comprising user information available for validating;
an authentication module for validating the authentication information received from the user device by comparing the authentication information with the user information; and
a processing module for generating a validation result, identifying a number of validation operations, and instructing the communication module to transmit the validation result.

17. A method for retrieving authentication information from an authentication server, the method comprising:
providing a sign-in interface to a user device, the sign-in interface comprising an authentication service option;
receiving an authentication request from the user device to use the authentication service option;
transmitting the authentication request to the authentication server;
receiving a validation result from the authentication server; and
based on a status of the validation result, allowing or not allowing access to the user device.

18. The method of claim 17, wherein the sign-in interface comprises a direct application server authentication option.

19. The method of claim 17, wherein transmitting the authentication request comprises transmitting authentication information received from the user device, the authentication information comprising physical authentication information obtained by the user device.

20. The method of claim 17, wherein the validation result comprises one or more information types selected from the group consisting of payment information, shipping information, and customer preference information.
